(19) United States
(12) Patent Application Publication
(10) Pub. No.: US 2006/0171661 A1
(43) Pub. Date: Aug. 3, 2006

(54) Transferring digital images to a storage medium

(76) Inventor: David H. Hanes, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/048,609

(22) Filed: Feb. 1, 2005

(51) Int. Cl. H04N 5/91

(52) U.S. Cl. 386/46

(57) ABSTRACT

Embodiments for transferring a set of digital images from an electronic device to a storage medium are provided. One embodiment comprises detecting the presence of the electronic device, and when the electronic device is detected, automatically retrieving a set of at least one digital image from the device for transfer to a removable storage medium, analyzing the set, adjusting the set based on the analysis of the set, and storing the set to the removable storage medium. Other embodiments comprise systems, apparatus and machine-readable medium for transferring digital images.

### BACKGROUND

Digital cameras and camcorders typically use memory cards, e.g., compact flash memory cards, for capturing and storing digital images including still images. In most cases, these memory cards are not intended as a permanent storage medium for the digital images. Rather, the digital images are usually transferred from the memory card of the digital camera or camcorder and stored as files on a more permanent storage medium such as a digital versatile disk (DVD), compact disk (CD) read only memory (ROM), disk drive or other storage medium.

Transferring digital images from a camera or camcorder to a more permanent storage medium to provide for easy viewing by an end user is often a cumbersome process that is prone to user error. Conventionally, digital images are first downloaded from the camera to a computer using, for example, proprietary software provided by the camera manufacturer. Typically, when downloaded, the images are temporarily stored as files on a computer hard drive. When storing the files, the user usually has the option to specify the storage location and, in many instances, the user is provided with a default location. The user also typically has the option to rename each file since each image typically has an alphanumeric designation that is not indicative or suggestive of the subject matter of the image. Once stored, a separate application is typically used to transfer and organize the files to a more readily usable format, e.g., a slideshow, on a sharable medium, e.g., a DVD, CD-ROM, etc.

Unfortunately, this process is unduly difficult and prone to error. When transferring files, it is common for users to forget where the downloaded files are stored on the computer hard drive. This can often be a problem since most image files look alike in the directories of a computer operating system. Further, DVD software often requires many steps to complete the project of storing the images on an optical medium. Due to these difficulties, consumers can become frustrated and confused when trying to keep track of their digital images.

### BRIEF DESCRIPTION OF THE DRAWINGS

FIG. 1 is a block diagram of one embodiment of a system for transferring images from an electronic device to a storage medium.

FIG. 2 is a flow chart of one embodiment of a process for transferring images from an electronic device to a storage medium.

### DETAILED DESCRIPTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

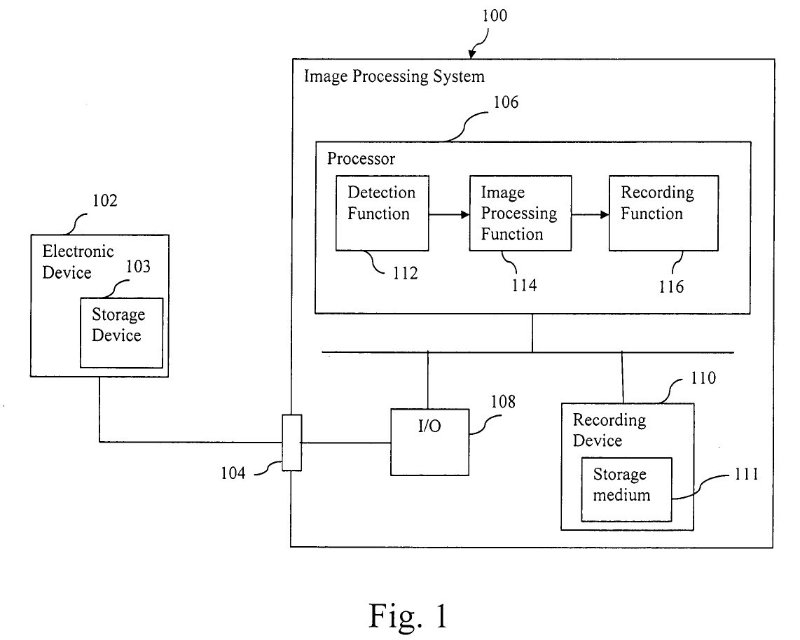

FIG. 1 is a block diagram of one embodiment of an image processing system, indicated generally at 100, for automatically transferring images from an electronic device 102 to a storage medium 111. In one embodiment, electronic device 102 comprises a digital camera or digital camcorder that is operable to capture and store digital images, e.g., still images. Further, storage medium 111 comprises, in one embodiment, a removable storage medium such as a digital video disk (DVD), compact disk (CD) or other appropriate storage media.

Advantageously, system 100 simplifies the process of transferring digital images from electronic device 102 to storage medium 111 by transferring the digital images with no direct input from the user other than communicatively connecting the electronic device 102 to system 100. The system 100 automates the process of transferring the images, in one embodiment, by triggering the transfer of images based on the detection of the presence of the electronic device 102; No additional input from a user is required. This automatic transfer demystifies the processing of digital images for those who are easily confused by the operation of modern computer systems. To use embodiments of system 100, a user essentially just plugs the electronic device 102 into system 100 and the digital images are automatically transferred to a removable storage medium. Further, in some embodiments, the data may be formatted into a slide show on a DVD, for example.

System 100 processes images in a number of different formats. In some embodiments, system 100 receives images from electronic device 102 in an industry standard format such as the Joint Photographic Experts Group (JPEG) format, Graphics Interchange Format (GIF) format, Portable Network Graphics (PNG) format, other bitmapped formats, or other appropriate standard format. In other embodiments, system 100 receives images in a proprietary format. In some embodiments, the files are stored with embedded metadata that provides information on the digital images. For example, in some embodiments, the metadata includes data specified in the Exchangeable Image Format (EXIF) standard, such as, information on the orientation of the image, various aspects of the quality of the image, etc.

Electronic device 102 stores the digital images on storage device 103. Storage device 103 comprises a storage medium that stores files in a manner compatible with the File Allocation Table (FAT) file system, such as, one or more of CompactFlash, Secure Digital (SD) memory card, MultiMedia cards (MMC) SmartMedia, MemoryStick or any other appropriate storage medium for storing the digital images in electronic device 102. In other embodiments, storage device 103 may use other file systems such as NT File System (NTFS), and Universal Disk Format (UDF). In some embodiments, electronic device 102 comprises a card reader that is adapted to receive one or more of the types of electronic storage media used in digital cameras and camcorders.

When a user is ready to download image files from electronic device 102, the user connects electronic device 102 to port 104. Port 104 of system 100 provides an interface for electronic device 102. In some embodiments, port 104 comprises a Universal Serial Bus (USB) port. In other embodiments, port 104 comprises a serial port, a FireWire port or a port using any appropriate protocol, whether currently existing or later developed, for exchanging data between electronic device 102 and system 100. Port 104 communicates with other parts of system 100 through input/output (I/O) device 108. Port 104 and I/O device 108, in some embodiments, comprise a common unit. Port 104 and I/O device 108 are implemented in hardware, software or a combination thereof.

Processor 106 of system 100 runs a number of functions that enable the automatic transfer of digital images from electronic device 102 to a removable storage medium 111 of recording device 110 without requiring user input or intervention. Processor 106 runs a detection function 112, image processing function 114 and recording function 116. Each of these functions is discussed in turn.

Detection function 112 determines when an electronic device 102 is present and coupled to port 104. In some embodiments, detection function 112 monitors for a “plug-and-play” event that is detected by the operating system of image processing system 100. In this embodiment, the detection function 112 learns of the presence of the electronic device 102 from the operating system. The operating system, in some embodiments, indicates the class of devices in which electronic device 102 falls. Based on the indication of the class of the device, detection function 112 determines whether electronic device 102 is the type of device that could have digital images for downloading. In other embodiments, the detection function 112 polls port 104 periodically for the attachment of electronic device 102. When detection function 112 determines that electronic device 102 is present and could have digital images to download, detection function 112 provides this information to image processing function 114.

Image processing function 114 processes digital images stored in storage device 103 of electronic device 102 when detection function 112 indicates electronic device 102 is present. In one embodiment, no user intervention is required to initiate the processing of digital images in storage device 103 by image processing function 114. Image processing function 114 retrieves the digital images from storage device 103 of electronic device 102. In some embodiments, as a preliminary step, image processing function 114 determines whether there are any digital images stored in storage device 103 that have not been previously downloaded and initiates downloads of any digital images so determined. In some embodiment, image processing function 114 also deletes the digital images from storage device 103 after successfully downloading the images to storage medium 111.

Image processing function 114 individually processes each digital image. Image processing function 114, in some embodiments, processes the digital images based on metadata stored with the digital images. For example, image processing function 114 rotates images in the X-Y plane so that all of the images are viewed in the same orientation. Further, image processing function 114 uses other information in the metadata to improve the quality of the images by, for example, making adjustments to brightness, contrast and other aspects of the digital images. Further, in some embodiments, image processing function 114 examines the content of the images and makes appropriate adjustments without the assistance of metadata. For example, in some embodiments, image processing function 114 uses an “autofix” algorithm to adjust the image based on the content of the image. A typical autofix algorithm analyzes the image and automatically adjusts one or more of brightness, sharpness, contrast, color, etc. In other embodiments, image processing function 114 uses a red-eye removal algorithm to adjust the image. A red eye removal algorithm detects an image of a face, then finds the eye(s) in the image, determines if red needs to be removed from the image, and removes the red, if necessary. Autofix and red eye reduction are provided here as examples of adjustments that can be made to images by image processing function 114 and are provided by way of example and not by way of limitation.

Recording function 116 controls the recording of the digital images to storage medium 111 by recording device 110. In some embodiments, recording device 110 comprises an optical disk burner. In other embodiments, recording device 110 comprises any other appropriate device for recording data on a storage medium, e.g., a disk drive, a tape drive, etc. In one embodiment, the digital images are burned or recorded on the optical disk in an industry standard format, e.g., a DVD-video format so that the images are viewable on a DVD player. Further, when still images are downloaded, in some embodiments, the still images are also stored on the disk as image files. Recording function 116, in one embodiment, records the images as a slide show presentation. In one embodiment, the recording function 116 comprises a DVD recording software program that automatically is launched when the image processing function 114 completes the download and processing of the images. The DVD software further automatically populates a slide show with the digital images.

In some embodiments, the DVD software provides for user interaction in setting up a slide show. For example, the user is prompted to modify the sequence of images once the slide show is populated by the DVD software. Further, in some embodiments, the user is prompted to add or modify other settings for the slide show such as backgrounds, colors, audio, video or other appropriate elements of a slide show display of digital images. Further, in some embodiments, the user is prompted to determine when to record the digital images to the storage medium 111. Further, in yet other embodiments, the user is prompted with a number of possible formats to record the images. In some embodiments, the user is given the option to have the user selections automatically applied to later slideshows recorded. When any appropriate selections are made, recording function 116 proceeds to record the digital images on the storage medium 111 in recording device 110 in the specified format consistent with the selections made.

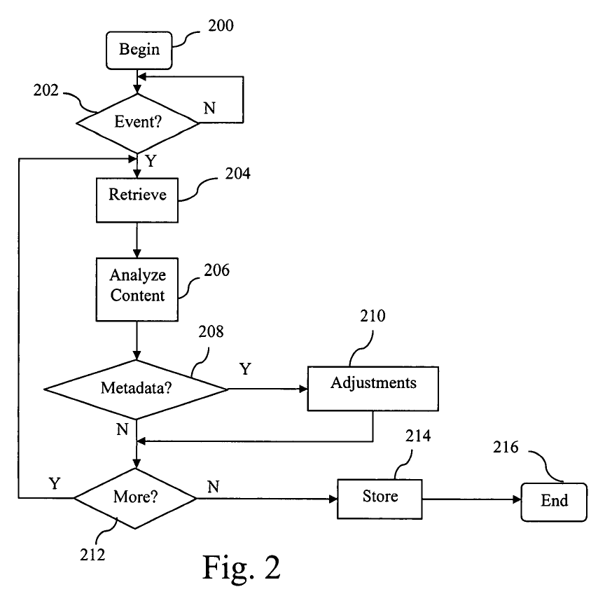

FIG. 2 is a flow chart of one embodiment of a process for automatically transferring images from an electronic device, such as a digital camera or digital. camcorder, to a storage medium, such as a digital video disk (DVD) or the like. The process begins at block 200 and waits for a triggering event to indicate that an electronic device with digital images is available for processing, e.g., a digital camera has been plugged in. At block 202, the process determines whether an event has occurred that indicates the electronic device is present. In one embodiment, the event is a “plug-and-play” event detected by a software operating system. In one embodiment, the plug-and-play event indicates the presence of a device that falls within a selected class. In other embodiments, other appropriate events are used to indicate the presence of an electronic device. If the event has not occurred, the process returns to block 202 and monitors for the occurrence of an event.

When an event is detected at block 202, the illustrated process automatically engages in processing of digital images on the electronic device without requiring further input from the user. At block 204, the process automatically retrieves images from the electronic device. In some embodiments, the process retrieves all of the images stored in the electronic device. In other embodiments, the process only retrieves images that have not been previously downloaded as indicated, for example, by a flag stored in the metadata of the image file. At block 206, the illustrated process automatically analyzes the content of the images. In one embodiment, the process analyzes metadata associated with the digital image files. The metadata, in one embodiment, comprises metadata such as specified in the EXIF standard. For example, the metadata indicates orientation of the digital image to enable rotation of the image for proper viewing. Further, in some embodiments, the process determines whether the metadata indicates that adjustments should be made to the images, e.g., the picture quality, image settings, orientation, etc. at block 208. If so, the process adjusts the image as appropriate based on the metadata at block 210. If, no changes are needed, the process proceeds to block 212. At block 212, the process determines whether there are other images to process. If so, the process returns to block 204. If there are no additional images to process, the process proceeds to block 214.

Once the images have been processed, the process automatically stores the images to a storage device at block 214. In some embodiments, the images are stored in a slide show presentation. The images, in some embodiments, are stored on a digital storage medium such as a digital video disk (DVD) or video CD (VCD). Further, in some embodiments, the process enables user input into the final format and storage of the images on the storage medium. For example, in one embodiment, the process launches a recording function that populates a slide show with the images. Once populated, the slide show is displayed to the user and the user is prompted to use editing functions to make changes to the location of the images, transitions between slides, backgrounds and other visual and audio elements as are known in the art. In some embodiments, a user is given the option to configure settings to be applied to future slideshows generated automatically by the process. For example, in one embodiment, the user is enabled to select transitions between images, music, sizes, image locations, etc.

Further, in one embodiment, the user is given a choice as to whether to burn the images to a DVD, CD or store the images in any other appropriate removable media. The process ends at block 216 with the images downloaded from the electronic device and stored on a storage medium, e.g., digital still photos downloaded from a digital camcorder or camera and stored on a DVD or CD as a digital slide show. Advantageously, some embodiments of the process automate the operations necessary to download the images from the camera to a storage medium so that the images are stored to the media with little or no user interaction other than plugging the camera into a storage system.

Those skilled in the art will recognize that the techniques and methods described here are implemented, in some embodiments, by programming a programmable processor with appropriate instructions to implement the functionality described here. In such embodiments, such program instructions are stored in a suitable memory device (for example, read-only memory and/or random-access memory) from which the program instructions are retrieved during execution. Also, suitable data structures are stored in memory in such embodiments.

The functions, methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a machine-readable medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a machine-readable medium, at least one input device, and at least one output device. Generally, a processor will receive instructions and data from a read-only memory and/or a random access memory. Machine-readable medium suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

What is claimed is:

1. A process for transferring a set of digital images from an electronic device to a storage medium, the process comprising:
detecting the presence of the electronic device; and
when the electronic device is detected, automatically:
retrieving a set of at least one digital image from the device for transfer to a removable storage medium;
analyzing the set;
adjusting the set based on the analysis of the set; and
storing the set to the removable storage medium.

2. The process of claim 1, wherein detecting the presence of the electronic device comprises determining when an operating system identifies an electronic device that is within a selected category of electronic devices.

3. The process of claim 1, wherein detecting the presence of the electronic device comprises processing information received from a plug-and-play function of an operating system.

4. The process of claim 1, wherein detecting the presence of the electronic device comprises periodically polling an interface for the presence of the electronic device.

5. The process of claim 1, wherein analyzing the set comprises analyzing metadata associated with the at least one digital image.

6. The process of claim 5, wherein adjusting the set of digital images comprises rotating at least one image in the X-Y plane based on orientation information in the metadata so that the image(s) of the set have a common X-Y orientation.

7. The process of claim 5, wherein adjusting the set comprises adjusting the image quality based on metadata information on the quality of the image.

8. The process of claim 1, wherein adjusting the set comprises examining the image content and making corrections.

9. The process of claim 1, wherein storing the set comprises burning the set to an optical storage medium.

10. The process of claim 1, wherein storing the set comprises storing the set as a slide show on an optical storage medium.

11. The process of claim 1, wherein storing the set comprises generating a slideshow from the set of digital images based on user-selectable options and storing the set of digital images on an optical medium.

12. A system for processing digital images, the system comprising:
a port for receiving an electronic device;
a detection function, communicatively coupled to the port, wherein the detection function determines when the electronic device is coupled to the port;
an image processing function, responsive to the detection function, wherein the image processing function automatically analyzes the content of the electronic device to identify a set of at least one digital image stored on the electronic device when the detection function determines that the electronic device is in a selected category of electronic devices; and
a recording function, responsive to the image processing function, wherein the recording function automatically stores the identified set on a removable storage medium.

13. The system of claim 12, wherein the recording function stores the identified set on an optical disk with an optical disk burner.

14. The system of claim 12, wherein the image processing function further analyzes metadata associated with the set.

15. The system of claim 12, wherein the image processing function further analyzes and adjusts the set without using metadata.

16. The system of claim 12, wherein the recording function stores the set of digital images as a slide show.

17. The system of claim 16, wherein the recording function prompts for input in creating the slide show.

18. A machine-readable medium having instructions stored thereon for a process, the process comprising:
automatically detecting the presence of an electronic device;
retrieving a set of at least one digital image from the electronic device for transfer to a removable storage medium without user input; and
automatically storing the set to the removable storage medium.

19. The machine-readable medium of claim 18, wherein detecting the presence of the electronic device comprises using data from a plug-and-play function.

20. The machine-readable medium of claim 18, wherein detecting the presence of the electronic device comprises polling an interface with a port for making a connection to the electronic device.

21. The machine-readable medium of claim 18, and further comprising modifying the set of at least one digital image based on metadata associated with the set.

22. An apparatus for automatically transferring digital images from an electronic device to a storage medium, the apparatus comprising:
means for detecting the presence of the electronic device when the electronic device is connected to the apparatus; and
means, responsive to the means for detecting, for automatically retrieving a set of at least one digital image from the electronic device for transfer to the removable storage medium upon detection of the presence of the electronic device.

23. The apparatus of claim 22, and further including means for storing the set to the removable storage medium in direct response to the means for automatically retrieving the set of digital images.

24. The apparatus of claim 22, wherein the means for automatically retrieving the set comprises means for identifying digital images on the electronic device that have not previously been transferred to a removable storage medium.
